(19) United States
(12) Patent Application Publication
(10) Pub. No.: US 2026/0008587 A1
(43) Pub. Date: Jan. 8, 2026

(54) Heat-Sealable Aluminium Alloy Strip for Beverage Can Lids

(71) Applicants: Ishak Bakirel, Köln (DE); Antonio Mateo, Grevenbroich (DE); Stefan Schlüter, Düsseldorf (DE); Marie Keil, Köln (DE); Karin Andrae, Mönchengladbach (DE)

(72) Inventors: Ishak Bakirel, Köln (DE); Antonio Mateo, Grevenbroich (DE); Stefan Schlüter, Düsseldorf (DE); Marie Keil, Köln (DE); Karin Andrae, Mönchengladbach (DE)

(73) Assignee: Speira GmbH, Grevenbroich (DE)

(21) Appl. No.: 19/326,366

(22) Filed: Sep. 11, 2025

Related U.S. Application Data
(63) Continuation of application No. PCT/EP2024/056489, filed on Mar. 12, 2024.

(30) Foreign Application Priority Data
Mar. 15, 2023 (EP) 23162014.7

(51) Int. Cl. B65D 17/28; B21B 1/22; C22F 1/04

(52) U.S. Cl. CPC B65D 17/4014; B21B 1/22; C22F 1/04; B21B 2001/225; B65D 2517/004; B65D 2517/0082

(57) ABSTRACT

An aluminium alloy strip for manufacturing a beverage can lid. The aluminium alloy strip has an aluminium alloy of the type AA5xxx. The object of specifying an aluminium alloy strip made of an aluminium alloy of the type AA5xxx for manufacturing a beverage can lid, which enables secure and cost-effective fastening of plastic elements on the manufactured beverage can lids, is achieved by the aluminium alloy strip having a heat-sealable coating, which contains polyolefin, on one side or on both sides.

### CROSS-REFERENCE TO RELATED PATENT APPLICATIONS

This patent application is a continuation of International Application No. PCT/EP2024/056489, filed on Mar. 12, 2024, which claims the benefit of priority to European Patent Application No. 23162014.7, filed Mar. 15, 2023, the entire teachings and disclosures of both applications are incorporated herein by reference thereto.

### FIELD OF THE INVENTION

The present invention relates to an aluminium alloy strip for manufacturing a beverage can lid, with the aluminium alloy strip having an aluminium alloy of the type AA5xxx. In addition, the invention relates to a method for manufacturing an aluminium alloy strip, with the method comprising: Casting a rolling ingot or a casting strip from an aluminium alloy of the type AA5xxx; homogenising the rolling ingot or the casting strip; hot rolling the rolling ingot or the casting strip into a hot strip; and cold rolling the hot strip to final thickness with at least one intermediate annealing or without intermediate annealing. Lastly, the invention relates to a use of an aluminium alloy strip, a resealable beverage can lid and a beverage can with a resealable beverage can lid.

### BACKGROUND OF THE INVENTION

Beverage cans are an important type of packaging for beverages. Usually, a beverage can consists of a beverage can body and a beverage can lid, which are connected to each other airtight via a flanging, for example. The beverage can body is primarily used to hold the beverage and can also be formed in multiple parts. On the one hand, the beverage can lid serves the purpose of securely closing the cavity formed by the beverage can body so that, for example, leakage of the beverage is prevented when storing or transporting the unopened beverage can. On the other hand, however, the beverage can lid is typically also designed in such manner that an opening can be created on the beverage can lid for the intended removal of the beverage by the consumer.

In addition to tinplate, aluminium alloys are primarily used as materials for the manufacture of beverage cans. The beverage can body and the beverage can lid usually consist in particular of different aluminium alloys due to different requirements for the respective materials. While aluminium alloys of the type AA3xxx have predominantly prevailed for beverage can bodies due to their good forming properties, aluminium alloys of the type AA5xxx, which have improved mechanical properties due to their higher magnesium content, are typically used for beverage can lids. This enables a higher internal pressure stability of the beverage can lid to be achieved, so that undesired bulging of the beverage can lid, for example with carbonated beverages, can be prevented.

Most of the beverage can lids used today have a mechanism that irreversibly creates an opening for removing the beverage. For example, the opening is created by pressing in a section of the beverage can lid, which is defined by a pre-punched predetermined break line. Resealing the created opening is not provided for with such a mechanism, which has a number of disadvantages: Firstly, this exposes the beverage to environmental influences such as dirt, dust and insects in a comparatively unprotected manner. Secondly, the beverage is not protected against spillage if, for example, the beverage can is moved vigorously or knocked over. Thirdly, carbon dioxide can easily escape from the beverage.

A mechanism with which a resealable opening of a beverage can lid can be created is, for example, known from the German utility model DE 29812116 U1. An additional, rotatable cover made of sheet metal is provided to close the created opening and open it again if necessary. However, metal sheets have the disadvantage that they may have sharp edges, which presents a not insignificant risk of injury to the consumer when actuating the resealable mechanism.

Therefore, considerations are being made to implement a resealable opening of a beverage can lid by attaching elements made of plastic to the beverage can lid. In accordance with this approach, the plastic elements are intended to ensure that the opening created for removing the beverage can be closed and opened again if necessary without there being a significant risk of injury from sharp metal edges for the consumer. However, a problem in implementing this approach is the secure and cost-effective fastening of the plastic elements on the beverage can lid. This as yet unresolved problem currently stands in the way of the further development and market launch of resealable openings for beverage can lids based on plastic elements. For example, in the event of an inadequately firm connection between the plastic elements and the beverage can lid, it could happen that the plastic elements become detached, causing the mechanism for resealing the beverage can lid to no longer function.

### SUMMARY OF THE INVENTION

Against this background, the object of the present invention is to specify an aluminium alloy strip made of an aluminium alloy of the type AA5xxx for manufacturing a beverage can lid, which enables a secure and cost-effective fastening of plastic elements on the manufactured beverage can lids. Furthermore, the invention also has the object of providing a method for manufacturing such an aluminium alloy strip, as well as specifying an advantageous use of the aluminium alloy strip. Lastly, the invention has set itself the object of specifying a resealable beverage can lid on which plastic elements can be securely and cost-effectively fastened, as well as a corresponding beverage can.

According to a first teaching of the invention, the above-mentioned object for an aluminium alloy strip for manufacturing a beverage can lid, with the aluminium alloy strip having an aluminium alloy of the type AA5xxx, is achieved by the aluminium alloy strip having a heat-sealable coating, which contains polyolefin, on one side or on both sides.

As part of the invention, it has turned out that a heat-sealable coating, which contains polyolefin, enables a secure and cost-effective fastening of plastic elements on an aluminium alloy strip, which has an aluminium alloy of the type AA5xxx. Because the coating of the aluminium alloy strip according to the invention is heat-sealable, the plastic elements can be fastened on beverage can lids, which were manufactured from the aluminium alloy strip according to the invention, by the simple and proven method of heat-sealing. In general, plastic parts are connected together during heat sealing by heating the joining surfaces of the parts to be connected and pressing them together so that they fuse together. The heat-sealable coating of the aluminium alloy strip according to the invention can also provide corresponding joining surfaces so that plastic elements can be connected to the aluminium alloy strip according to the invention by means of the heat-sealable coating. As could further be shown within the scope of the invention, a connection established by heat sealing between the heat-sealable coating of the aluminium alloy strip and the plastic elements of a resealable beverage can lid fastened thereto is able to permanently provide the adhesive forces necessary for a secure connection. The heat-sealable coating serves as an adhesion promoter between the aluminium alloy of the beverage can lid and the plastic elements. Since the heat-sealing method also enables efficient production of high quantities, cost-effective fastening of the plastic elements is also achieved.

Since the heat-sealable coating of the aluminium alloy strip according to the invention contains polyolefin, the coating also has a high health compatibility, meaning that it complies with applicable food safety regulations. In particular, the heat-sealable coating of the aluminium alloy strip according to the invention is free of formaldehyde, bisphenol A (BPA), melamine, polytetrafluoroethylene (PTFE) and styrene. Due to the harmful effects of these substances on health, their use in the food sector is either restricted to strict limit values or even completely prohibited in many countries. However, the heat-sealable coating of the aluminium alloy strip according to the invention is based on polyolefin, which is unproblematic in this respect, and does not contain any of the aforementioned substances, so that the coating accordingly has a high health compatibility and complies with food safety regulations.

It has furthermore emerged that the heat-sealable coating of the aluminium alloy strip according to the invention is also readily suitable for the manufacturing methods of beverage can lids, in particular for the forming processes necessary therefor.

The aluminium alloy strip according to the invention has a heat-sealable coating, which contains polyolefin, on one side or on both sides. In the case of a one-sided coating, the heat-sealable coating is preferably applied on the side of the aluminium alloy strip which corresponds to an outer side of a beverage can lid and is not intended to come into contact with a beverage filled therein prior to opening a beverage can. In this way, the plastic elements for a resealable beverage can lid can be fastened on the outer side. In the case of a two-sided coating, the heat-sealable coating is preferably also applied on the side of the aluminium alloy strip which corresponds to an inner side of a beverage can lid and is intended to come into contact with a beverage filled therein prior to opening a beverage can. In this context, it has been shown that the heat-sealable coating of the aluminium alloy strip according to the invention also acts as a highly functional barrier between the aluminium alloy of the beverage can lid and the beverage. In particular, on the one hand, the heat-sealable coating protects the beverage against the migration of aluminium from the can lid material. On the other hand, the aluminium alloy of the beverage can lid is also protected against attack by the beverage, for example if the beverage is carbonated. In addition, the heat-sealable coating of the aluminium alloy strip according to the invention also fulfils the function of a highly functional barrier on an outer side of a beverage can lid, for example if the beverage comes into contact with the outer side of the beverage can lid during drinking or as a result of drinking.

In a preferred embodiment of the aluminium alloy strip according to the invention, the polyolefin is polyethylene or polypropylene or a blend of both. Polyethylene (PE) and polypropylene (PP) are the two most widely used polyolefins and are particularly cost-effective. Preferably, the heat-sealable coating of the aluminium alloy strip according to the invention contains the same polyolefin, from which the plastic elements to be fastened are also manufactured, since in this case the fusion takes place particularly reliably during heat-sealing and thus a particularly secure connection is created.

In a preferred embodiment of the aluminium alloy strip according to the invention, the polyolefin is at least partially cross-linked. In the cross-linking of a polyolefin, and generally of a polymer, the chain-shaped macromolecules of the polymer are linked to a three-dimensional network by chemical reactions. The cross-linking results, among other things, in an increase in the hardness and toughness of the polymer and a decrease in its solubility. This is advantageous for the manufacture of beverage can lids, as both the mechanical and chemical resistance of the heat-sealable coating is improved.

In a preferred embodiment of the aluminium alloy strip according to the invention, the polyolefin is at least partially cross-linked by a hydroxyalkylamide. Preferably, the hydroxyalkylamide is N,N,N′,N′-Tetrakis(2-hydroxyethyl) adipamide. Hydroxyalkylamides, and in particular the mentioned N,N,N′,N′-Tetrakis(2-hydroxyethyl) adipamide, are well suited for crosslinking polyolefins due to their chemical properties, so that an effective crosslinking takes place. N,N,N′,N′-Tetrakis(2-hydroxyethyl) adipamide as a crosslinking agent also has the advantages that it is suitable for use in the food sector and that the resulting crosslinked polyolefin has a high resistance to weathering influences such as for example ultraviolet radiation.

In a preferred embodiment of the aluminium alloy strip according to the invention, the heat-sealable coating contains wax. Preferably, this is a PTFE-free wax such as for example carnauba wax, polyethylene wax, polypropylene wax, polyamide wax or a mixture of the said waxes. Because the heat-sealable coating of the aluminium alloy strip according to the invention contains wax, the surface smoothness and surface hardness of the heat-sealable coating can be increased. This has an advantageous effect on the handling of the aluminium alloy strip and the beverage can lids manufactured from it in production processes, for example when conveyed within a production line, and also improves the punchability of the aluminium alloy strip. In addition, PTFE-free wax is generally also unproblematic in terms of health compatibility and food safety regulations.

In a preferred embodiment of the aluminium alloy strip according to the invention, the heat-sealable coating has an basis weight of 1.0 g/m² to 20.0 g/m². Preferably, the heat-sealable coating has an basis weight of 2.0 g/m² to 14.0 g/m². Particularly preferably, the heat-sealable coating has an basis weight of 3.0 g/m² to 5.0 g/m² or 6.0 g/m² to 12.5 g/m². Most preferably, the heat-sealable coating has an basis weight of 3.5 g/m² to 4.5 g/m² or 6.5 g/m² to 12.0 g/m². The specified area weights are respectively dry weights. At given mass density, the basis weight of the heat-sealable coating correlates with the thickness of the heat-sealable coating. Because the heat-sealable coating has an basis weight in the range of 1.0 g/m² to 20.0 g/m², a good compromise between adequate seal seam strength and low material use can be achieved. A particularly good compromise is achieved in the preferred range of 2.0 g/m² to 14.0 g/m². A lower area weight, in particular in the particularly preferred range of 3.0 g/m² to 5.0 g/m² or most preferably 3.5 g/m² to 4.5 g/m², leads to lower material use and thus to a cost reduction. A higher area weight, in particular in the particularly preferred range of 6.0 g/m² to 12.5 g/m² or most preferably 6.5 g/m² to 12.0 g/m², leads to a higher seal seam strength and thus to a more secure fastening of the plastic elements.

In a preferred embodiment of the aluminium alloy strip according to the invention, the heat-sealable coating, after heat-sealing against a polypropylene film with a sealing force of 90 N, a sealing time of 1 s and a sealing temperature of 180° C., has a seal seam strength of at least 35 N at a sealing seam width of 15 mm. Preferably, the heat-sealable coating, after heat-sealing against a polypropylene film with the mentioned parameters of sealing force, sealing time, sealing temperature and sealing seam width, has a seal seam strength of at least 39 N. Particularly preferably, the heat-sealable coating, after heat-sealing against a polypropylene film with the stated parameters, has a seal seam strength of at least 42 N. For example, the seal seam strength can be determined in accordance with DIN 55529. The term ‘seal seam strength’ is to be understood as being synonymous with the term ‘separation force’ used in DIN 55529, which is always specified as an arithmetic mean value. During the heat sealing against a polypropylene film, which must be carried out in advance, it must be ensured that a sufficiently thick polypropylene film is used so that the polypropylene film does not tear due to the comparatively high sealing forces when determining the seal seam strength. In this context, for example, the thickness of the polypropylene film should be 200 μm or more. Since the heat-sealable coating of the aluminium alloy strip according to the invention has a seal seam strength of at least 35 N under the aforementioned conditions, it can be achieved that the adhesive forces required for a secure connection between the heat-sealable coating and the plastic elements to be fastened are provided to a sufficient extent. Consequently, an adequately secure fastening is achieved. A higher seal seam strength, preferably at least 39 N or particularly preferably at least 42 N, can provide correspondingly higher adhesive forces so that an even more secure fastening is achieved.

In a preferred embodiment of the aluminium alloy strip according to the invention, the heat-sealable coating has a porosity with which the current strength measured in the “enamel rater” porosity measurement at an basis weight of the heat-sealable coating in the range of 8 g/m² to 12 g/m² is no more than 5 mA, with the “enamel rater” porosity measurement being carried out with a direct voltage of 6.3 V and the current strength being determined after a measuring time of 4 s. Preferably, the heat-sealable coating has a porosity with which the current strength measured under these conditions is no more than 2 mA. Particularly preferably, the heat-sealable coating has a porosity with which the measured current strength is no more than 1 mA. Preferably, the “enamel rater” porosity measurement is carried out on a beverage can lid shell manufactured from the aluminium alloy strip. The “enamel rater” porosity measurement is a common measuring method in the packaging industry for testing electrically non-conductive coatings on metallic materials, which is carried out on test pieces of the coated metallic material. In connection with beverage can lids, so-called beverage can lid shells are used as test pieces. A beverage can lid shell refers here to a preliminary product of a beverage can lid which has already been punched and formed, but does not yet have the final shape of a beverage can lid and also does not have a pull tab for opening the beverage can lid. To carry out the “enamel rater” porosity measurement, a test arrangement is selected in which the test piece comes into contact with an electrolyte solution on the coated side. The electrolyte solution is electrically contacted via a first electrode. A second electrode is connected to the metal layer of the test piece. A DC voltage, which is usually 6.3 V, is then applied between the electrodes. As the coating of the test piece is an electrical isolator, a current flow between the electrodes via the electrolyte can only occur due to unlacquered points or pores in the coating of the test piece. The measured current strength is therefore a measure of the area of unlacquered points or pores in the coating of the test piece. The higher the measured current strength, the greater the porosity. Since the measured current strength usually does not immediately assume a steady value, the current strength is usually determined after a measuring time of 4 s, during which a steady value is usually present. The measured current strength is also dependent on the thickness and hence the basis weight of the coating, as unlacquered areas or pores are more likely to occur at lower thicknesses than at higher thicknesses. In connection with beverage can lids, with an basis weight of the coating in the range of 8 g/m² to 12 g/m², it can be assumed that a current strength measured in the “enamel rater” porosity measurement of no more than 5 mA corresponds to a sufficiently low porosity of the coating. In particular, it can therefore be achieved with a measured current strength of no more than 5 mA for the heat-sealable coating of the aluminium alloy strip according to the invention that the heat-sealable coating adequately fulfils its function as a highly functional barrier, and as an adhesion promoter, due to its sufficiently low porosity. At a measured current strength of preferably no more than 2 mA and particularly preferably no more than 1 mA, a coating with correspondingly lower porosity and thus improved properties can be provided as a highly functional barrier or adhesion promoter.

In a preferred embodiment of the aluminium alloy strip according to the invention, the aluminium alloy strip has an aluminium alloy of the type AA5052 or AA5182. Due to their high magnesium content and the associated mechanical properties, the aforementioned aluminium alloys are particularly well suited for the manufacture of beverage can lids. In addition, they are readily suitable for being provided with the heat-sealable coating.

In a preferred embodiment of the aluminium alloy strip according to the invention, the aluminium alloy strip has a metal thickness of 0.1 mm to 0.3 mm, preferably from 0.15 mm to 0.25 mm. The metal thickness does not include the thickness of the heat-sealable coating or other coatings. Because the aluminium alloy strip has a metal thickness of 0.1 mm to 0.3 mm, a good compromise can be achieved between sufficient mechanical strength on one hand and low material use and low weight on the other hand. On the one hand, a lower metal thickness leads to a lower material use and thus to a reduction in costs. On the other hand, a lower metal thickness also results in a lower weight of the beverage can lid, which is in particular advantageous for transporting the beverage cans. A higher metal thickness, on the other hand, leads to a better mechanical strength and thus in particular to a higher internal pressure stability of the beverage can lid. In the preferred range of metal thickness from 0.15 mm to 0.25 mm, a particularly good compromise between sufficient mechanical strength on one hand and low material use and low weight on the other hand is achieved.

In a preferred embodiment of the aluminium alloy strip according to the invention, the aluminium alloy strip additionally has a chromium-free conversion layer on one side or on both sides. Preferably, the one-sided or two-sided chromium-free conversion layer is arranged directly on the metal layer of the aluminium alloy strip and is covered by a heat-sealable coating. Because the aluminium alloy strip according to the invention has a conversion layer, improved corrosion protection can be achieved on the one hand as well as improved adhesion of the heat-sealable coating on the other hand. A chromium-free conversion layer is better suited for contact with food than a chromium-containing conversion layer. Preferably, the chromium-free conversion layer contains zirconium phosphate. This makes it possible to achieve particularly good adhesive properties compared to the heat-sealable coating containing polyolefins. In principle, however, the aluminium alloy strip according to the invention can also be implemented with conversion layers containing other metal phosphates such as titanium phosphate or chromium phosphate.

In a preferred embodiment of the aluminium alloy strip according to the invention, the aluminium alloy strip has at least one further layer on one side or on both sides. For example, the aluminium alloy strip according to the invention can have a further polymer layer on one side or on both sides, preferably a film consisting of polyolefin, preferably a polyethylene film or polypropylene film or a film consisting of a blend of both polymers. Both on the side of the aluminium alloy strip that corresponds to an inner side of a beverage can lid and on the side that corresponds to an outer side, such a polymer layer can be used to improve the mechanical properties of the aluminium alloy strip. This can in particular improve the internal pressure stability of a beverage can lid manufactured from the aluminium alloy strip according to the invention. By means of a polymer layer on the inner side, it can also be achieved that, on the one hand, the beverage is better protected against the migration of aluminium from the can lid material and, on the other hand, the aluminium alloy of the beverage can lid is better protected against an attack by the beverage. A polymer layer on the outer side can also be used to protect against external influences such as for example mechanical stresses.

According to a second teaching of the invention, the above-mentioned object is achieved for a method for manufacturing an aluminium alloy strip, with the method comprising:
casting a rolling ingot or a casting strip from an aluminium alloy of the type AA5xxx;
homogenising the rolling ingot or the casting strip;
hot rolling the rolling ingot or the casting strip into a hot strip;
cold rolling the hot strip to final thickness with at least one intermediate annealing or without intermediate annealing;
   in that the method further comprises:
producing a heat-sealable coating on one side or on both sides of the aluminium alloy strip cold-rolled to final thickness, with the heat-sealable coating containing polyolefin.

By means of the method steps of casting a rolling ingot or a casting strip from an aluminium alloy of the type AA5xxx, homogenising the rolling ingot or the casting strip, hot rolling the rolling ingot or the casting strip into a hot strip and cold rolling the hot strip to final thickness with at least one intermediate annealing or without intermediate annealing, an aluminium alloy strip made of an aluminium alloy of the type AA5xxx can be produced reliably and efficiently. If the method is carried out with at least one intermediate annealing, the solidifications created during cold rolling can be removed so that lower strengths in the rolled-hard state are possible at the final thickness. In principle, however, the method can also be carried out without intermediate annealing. Optionally, the aluminium alloy strip can also undergo a final heat treatment after cold rolling, which can also remove solidifications.

Since the method according to the invention comprises, as an additional method step, creating a heat-sealable coating on one side or on both sides of the aluminium alloy strip cold-rolled to final thickness, with the heat-sealable coating containing polyolefin, a corresponding heat-sealable coating with the advantages that have already been explained in connection with the first teaching can be provided on the aluminium alloy strip. In particular, therefore, an aluminium alloy strip according to the first teaching of the invention is manufactured with the method according to the second teaching of the invention.

In a preferred embodiment of the method according to the invention, the heat-sealable coating is produced by applying and baking a lacquer. This enables the heat-sealable coating to be provided in a cost-effective and reliable manner. In principle, however, the heat-sealable coating can also be produced by other suitable methods such as for example extrusion coatings or lamination on the aluminium alloy strip cold-rolled to final thickness.

In a preferred embodiment of the method according to the invention, the lacquer is a water-based lacquer. A water-based lacquer has the advantage of a better environmental compatibility compared to a conventional solvent-based lacquer. In addition, a water-based lacquer is also less problematic with regard to health compatibility and food safety regulations, as it does not contain any aminoplasts such as for example melamines or benzoguamines as reaction partners.

In a preferred embodiment of the method according to the invention, the lacquer contains a polyolefin dispersion. Due to the fine distribution of the polyolefin in the dispersion, a homogeneous heat-sealable coating can be produced during application and baking of the lacquer.

In a preferred embodiment of the method according to the invention, the polyolefin dispersion is a polyethylene dispersion or a polypropylene dispersion or a mixture of both. Accordingly, the polyolefin contained in the heat-sealable coating produced is polyethylene or polypropylene or a corresponding blend. Polyethylene (PE) and polypropylene (PP) are the two most widely used polyolefins and are therefore particularly cost-effective. Preferably, the polyolefin dispersion is a dispersion of the same polyolefin from which the plastic elements of the resealable beverage can lid to be fastened are also manufactured. In this case, fusion takes place particularly reliably during heat sealing, so that a particularly secure connection is created.

In a preferred embodiment of the method according to the invention, the lacquer contains a crosslinking agent. As a result, it can be achieved that the polyolefin is at least partially cross-linked, so that both the mechanical and the chemical resistance of the heat-sealable coating are improved, as has already been carried out in connection with the first teaching.

In a preferred embodiment of the method according to the invention, the lacquer contains a hydroxyalkylamide as a crosslinking agent. Preferably, the hydroxyalkylamide is N,N,N′,N′-Tetrakis(2-hydroxyethyl) adipamide. By using a hydroxyalkylamide as a crosslinking agent, and in particular by using N,N,N′,N′-Tetrakis(2-hydroxyethyl) adipamide, an effective crosslinking of the polyolefin, suitability for use in the food sector and a high weather resistance can be achieved, as already stated in connection with the first teaching.

In a preferred embodiment of the method according to the invention, the lacquer contains wax. Preferably, this is a PTFE-free wax such as for example carnauba wax, polyethylene wax, polypropylene wax, polyamide wax or a mixture of the said waxes. Because the lacquer contains wax, the surface smoothness and surface hardness of the heat-sealable coating can be increased and thus, among other things, the punchability of the aluminium alloy strip can be improved. In addition, PTFE-free wax is generally also unproblematic in terms of health compatibility and food safety regulations.

In a preferred embodiment of the method according to the invention, the water-based lacquer contains 1 to 15 wt %, preferably 2 to 6 wt % of an aqueous solution of a hydroxyalkylamide, 1 to 20 wt %, preferably 5 to 11 wt % of PTFE-free wax and as a remainder an aqueous polyolefin dispersion. The aqueous polyolefin dispersion may have a solids content of up to 60 wt %, preferably 40 to 50 wt %. Furthermore, the aqueous polyolefin dispersion may preferably be an aqueous polyethylene dispersion or an aqueous polypropylene dispersion. The aqueous solution of a hydroxyalkylamide may preferably be a solution of 10 to 90 wt %, preferably 20 to 40 wt % of N,N,N′,N′-Tetrakis(2-hydroxyethyl) adipamide in deionized water or in slightly alkaline water, which contains 0.1 to 0.5 wt % of N,N-dimethylethanolamine (DMEA). The PTFE-free wax may for example be carnauba wax, polyethylene wax, polypropylene wax, polyamide wax or a mixture of the said waxes. With the specified composition of the water-based lacquer, it is possible to achieve that the heat-sealable coating is produced cost-effectively on the one hand and that the advantageous properties of the heat-sealable coating are reliably established on the other hand.

In a preferred embodiment of the method according to the invention, the lacquer is applied in a one-sided or two-sided coil coating method. In a coil coating method, the aluminium alloy strip to be coated is unwound from one coil, coated and rewound onto another coil. This allows easy handling of the aluminium alloy strip for the purpose of coating. In principle, however, the method according to the invention can also be implemented with other methods for handling the aluminium alloy strip.

In a preferred embodiment of the method according to the invention, the lacquer is applied using a one-sided or two-sided roll coating method. In the roll coating process, the coating is applied to the aluminium strip by rolling on one side or on two sides. This allows the thickness or basis weight of the coating to be set very precisely, even at high coating speeds, so that reliable coating can be achieved. In principle, however, the method according to the invention can also be implemented with other coating methods. For example, the coating can also be applied by spraying, preferably by electrostatic spraying.

In a preferred embodiment of the method according to the invention, the lacquer is baked in such manner that a maximum metal temperature in the range of 200° C. to 300° C., preferably in the range of 220° C. to 260° C., is achieved. With the specified ranges of maximum metal temperature, a reliable through-hardening of the heat-sealable coating can be achieved without noticeable softening of the aluminium alloy strip. The bake time, i.e. the duration of a heating process at the end of which the maximum metal temperature is reached, can for example be in the range of 5 s to 35 s, preferably in the range of 8 s to 25 s.

According to a further preferred embodiment of the method, after the application and baking of the heat-sealable coating, a further polymer layer in the form of a heat-sealable film consisting of polyolefin, preferably a polyethylene or polypropylene film, is applied. Particularly in the strip-shaped state, a surface coating of the strip with a polyolefin film, preferably polyethylene or polypropylene film or a film made of a blend of the two polymers can be carried out by applying a corresponding polyolefin film, for example by lamination or hot lamination in a particularly economical manner.

In a preferred embodiment of the method according to the invention, the rolling ingot or the casting strip is cast from an aluminium alloy of the type AA5052 or AA5182. These aluminium alloys have in particular advantageous mechanical properties, as has already been explained in connection with the first teaching.

In a preferred embodiment of the method according to the invention, the hot strip is cold-rolled to final thickness of up to a metal thickness of 0.1 mm to 0.3 mm, preferably from 0.15 mm to 0.25 mm. The metal thickness does not include the thickness of the heat-sealable coating or other coatings. Due to the mentioned ranges of metal thickness, a good compromise can be achieved between sufficient mechanical strength and low material use as well as low weight, as already explained in connection with the first teaching.

In a preferred embodiment of the method according to the invention, the aluminium alloy strip is subjected to a chromium-free phosphating on one side or on both sides. Preferably, the chromium-free phosphating is carried out using zirconium phosphate. By means of a chromium-free phosphating, preferably using zirconium phosphate, a chromium-free conversion layer, preferably containing zirconium phosphate, can be produced on one side or on both sides of the aluminium alloy strip, the advantages of which have already been explained in connection with the first teaching. In principle, however, other metal phosphates, such as titanium phosphate or chromium phosphate, can also be used for phosphating instead of zirconium phosphate. Preferably, the phosphating takes place such that the conversion layer produced on one or both sides is arranged directly on the metal layer of the aluminium alloy strip and is covered by a subsequently applied heat-sealable coating. Particularly preferably, the phosphating can be carried out together with the coil coating method for applying the lacquer, i.e. “in line”. This eliminates the need for winding and unwinding the aluminium alloy strip, resulting in better process efficiency. The phosphating is preferably done in a no-rinse process, in which no rinsing step is required, as the phosphating agent is applied to the aluminium alloy strip and dried. Compared to phosphating processes with rinsing steps, no-rinse processes are more economical and environmentally friendly.

According to a third teaching of the invention, the above-mentioned object for a use of an aluminium alloy strip is achieved in that the aluminium alloy strip according to the first teaching is used to manufacture a resealable beverage can lid. In this context, the aluminium alloy strip according to the first teaching, in particular due to the heat-sealable coating, which contains polyolefin, enables a secure and cost-effective fastening of the plastic elements of the resealable beverage can lid on the aluminium alloy strip by means of the simple and proven heat-sealing method. With regard to further configurations and advantages of the use according to the invention, reference is also made to the explanations in connection with the first teaching.

According to a fourth and fifth teaching of the invention, the above-mentioned object for a resealable beverage can lid as well as for a beverage can with a resealable beverage can lid is achieved in that the beverage can lid is manufactured from an aluminium alloy strip according to the first teaching. Again, the aluminium alloy strip according to the first teaching enables a secure and cost-effective fastening of the plastic elements of the resealable beverage can lid. With regard to further configurations and advantages of the resealable beverage can lid according to the invention and the beverage can according to the invention, reference is also made to the embodiments in connection with the first teaching.

### BRIEF DESCRIPTION OF THE DRAWINGS

The invention will be explained in greater detail below by describing exemplary embodiments in connection with the drawing. The drawing shows

FIG. 1a, 1b show exemplary embodiments of aluminium alloy strips according to the invention according to the first teaching in a schematic sectional view;

FIG. 2a, 2b show an exemplary embodiment of a method according to the invention according to the second teaching in a schematic representation;

FIG. 3 show example of a beverage can according to the invention according to the fifth teaching with a beverage can lid according to the invention according to the fourth teaching in a schematic representation.

### DETAILED DESCRIPTION

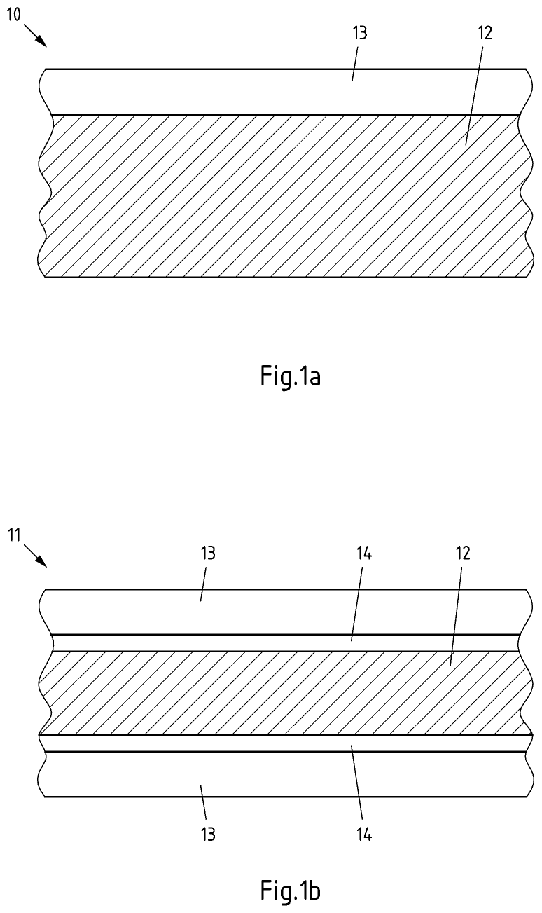

FIGS. 1a and 1b each show an exemplary embodiment of an aluminium alloy strip 10, 11 according to the invention in a schematic sectional view. For this purpose, FIG. 1a initially shows an aluminium alloy strip 10 with a metal layer 12 and a heat-sealable coating 13 applied on one side. By means of the heat-sealing method, plastic elements for implementing a resealable beverage can lid can be securely and cost-effectively fastened to the heat-sealable coating 13, such that the aluminium alloy strip 10 is particularly suitable for manufacturing a resealable beverage can lid. In addition, the polyolefin-containing heat-sealable coating 13 is also highly compatible with health and unproblematic with regard to currently applicable food safety regulations.

The metal layer 12 of the aluminium alloy strip 10 is made of an aluminium alloy of the type AA5xxx, here by way of example of the type AA5182, which has a high strength due to its high magnesium content and is therefore well suited for the manufacture of beverage can lids. Furthermore, the metal layer 12 has, by way of example, a thickness of 0.2 mm. Among other things, this thickness can ensure sufficient internal pressure stability of the beverage can lid. At the same time, the weight of the beverage can lid and the material use for its manufacture are limited to a reasonable extent.

The heat-sealable coating 13 of the aluminium alloy strip 10 contains, by way of example, polypropylene as polyolefin, as well as PTFE-free wax. The polypropylene is cross-linked using a hydroxyalkylamide, here by way of example using N,N,N′,N′-Tetrakis(2-hydroxyethyl) adipamide. As a result of cross-linking, the mechanical and chemical resistance of the heat-sealable coating 13 is improved. In this context, hydroxyalkylamides are well suited as crosslinking agents for polyolefins due to their chemical properties. In addition, the N,N,N′,N′-Tetrakis(2-hydroxyethyl) adipamide used here by way of example is not problematic with regard to use in the food sector. The PTFE-free wax also contained in the heat-sealable coating 13 increases the surface smoothness and surface hardness of the heat-sealable coating 13 and thus improves, among other things, the punchability of the aluminium alloy strip 10.

The basis weight of the heat-sealable coating 13 lies in the range of 1.0 g/m² to 20.0 g/m², preferably in the range of 2.0 g/m² to 14.0 g/m², whereby a good compromise between sufficiently secure fastening of the plastic elements and low material use can be achieved. Furthermore, the seal seam strength of the heat-sealable coating 13, after heat-sealing against a polypropylene film with a sealing force of 90 N, a sealing time of 1 s and a sealing temperature of 180° C., is at least 35 N at a sealing seam width of 15 mm. This allows the plastic elements to be fastened securely enough. Lastly, the heat-sealable coating has a porosity with which the current strength measured in the “enamel rater” porosity measurement is no more than 5 mA at an basis weight of the heat-sealable coating in the range of 8 g/m² to 12 g/m², with the “enamel rater” porosity measurement being carried out with a direct voltage of 6.3 V and the current strength being determined after a measuring time of 4 s. This ensures that the porosity of the heat-sealable coating 13 is sufficiently low such that the heat-sealable coating 13 adequately fulfils its property as an adhesion promoter and as a highly functional barrier.

A further exemplary embodiment of an aluminium alloy strip 11 according to the invention is also shown in FIG. 1b in a schematic sectional view. This aluminium alloy strip 11 also has a metal layer 12 as well as a heat-sealable coating 13 on both sides. With regard to the metal layer 12 and the heat-sealable coatings 13 of the aluminium alloy strip 11, the above explanations apply analogously to the aluminium alloy strip 10 shown in FIG. 1a.

Unlike the aluminium alloy strip 10 from FIG. 1a, the aluminium alloy strip 11 shown in FIG. 1b is, however, provided on both sides with a heat-sealable coating 13. In the case of a beverage can lid manufactured from the aluminium alloy strip 11, the heat-sealable coating 13 on the upper side primarily serves the purpose of fastening the plastic elements for implementing a resealable beverage can lid. On the other hand, the heat-sealable coating 13 on the underside acts primarily as a highly functional barrier. In this function, the heat-sealable coating 13 protects the beverage on the one hand against the migration of aluminium from the can lid material and on the other hand protects the aluminium alloy of the beverage can lid against an attack by the beverage.

In addition, the aluminium alloy strip 11 represented in FIG. 1b has a conversion layer 14 on both sides, in addition to the metal layer 12 and the two-sided heat-sealable coatings 13. The exemplary conversion layers 14 shown are chromium-free, preferably contain zirconium phosphate and are arranged directly on the metal layer 12 such that they are each covered by the heat-sealable coatings 13. In addition to protection against corrosion, the conversion layers 14 in particular result in an improved adhesion of the heat-sealable coatings 13. As the conversion layers 14 do not contain any harmful chromium, they are well suited for contact with food. The preferred inclusion of zirconium phosphate also ensures particularly good adhesion of the heat-sealable coatings 13 containing polyolefins.

In principle, further layers may also be present on the aluminium alloy strips 10, 11 represented in FIGS. 1a and 1b. For example, the aluminium alloy strip 11 from FIG. 1b on a side, which corresponds to an inner side of a beverage can lid, could have a polymer layer as a barrier layer and/or for improving the internal pressure stability of the beverage can lid. In addition or alternatively, the aluminium alloy strip 11 could have a polymer layer on one side, which corresponds to an outer side of a beverage can lid, as protection against external influences and/or also for improving the internal pressure stability of the beverage can lid.

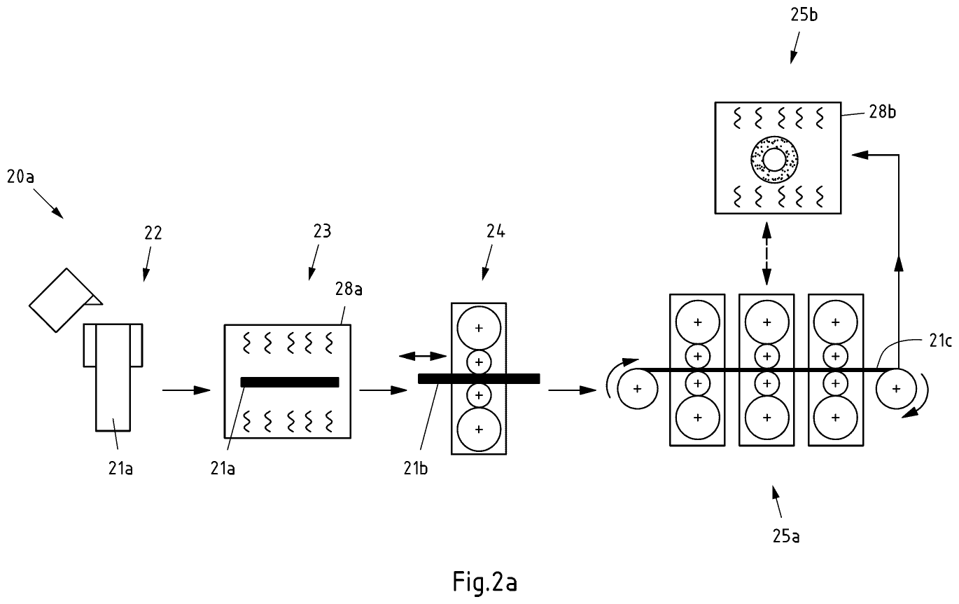

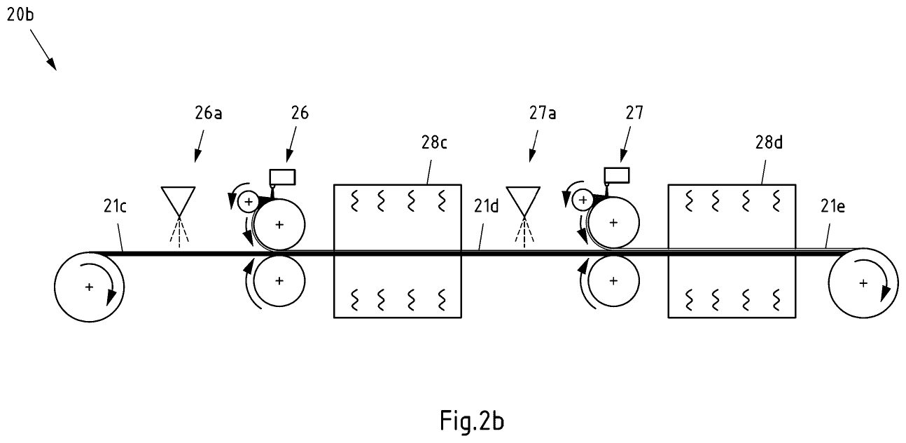

FIGS. 2a and 2b now show in a schematic view an exemplary embodiment of a method according to the invention for manufacturing an aluminium alloy strip, in particular for manufacturing an aluminium alloy strip according to the invention. FIG. 2a shows the method steps 20a from casting the rolling ingot up to and including cold rolling the hot strip to final thickness. FIG. 2b shows the method steps 20b for coating the aluminium alloy strip after cold rolling.

First, in step 22, a rolling ingot 21a is manufactured from an aluminium alloy of the type 5xxx. The rolling ingot 21a is manufactured, as schematically represented here, for example in the discontinuous direct chill (DC) casting method. Alternatively, however, other casting methods, such as in particular continuous strip casting (not represented), can also be used. After casting, the rolling ingot 21a is homogenised in step 23 using a homogenising furnace 28a. The hot rolling of the rolling ingot 21a into a hot strip 21b is then carried out in step 24. Hot rolling 24 can be carried out in reversing stands (as represented) and/or in tandem stands with multiple passes (not represented). The hot strip 21b is then cold-rolled to final thickness in step 25a into a cold strip 21c. During the cold rolling 25a, at least one optional intermediate annealing 25b can be carried out, here by way of example using a chamber furnace 28b, alternatively also using a continuous flow furnace (not represented). A softening of the cold strip 21c is achieved by the at least one optional intermediate annealing 25b. Consequently, further cold rolling steps 25a can be carried out following the at least one optional intermediate annealing 25b until the cold strip 21c has reached the final thickness of 0.2 mm here by way of example. A final heat treatment is also possible, which also serves to soften the cold strip 21c in order to be able to further process it better if necessary. For this purpose, the cold strip with final thickness, for example in the coil, is subjected to a heat treatment, for example in a chamber furnace.

The method steps 20b, which are carried out following the cold rolling 25a, are shown in FIG. 2b. The starting point for this is the cold-rolled and optionally finally heat-treated cold strip 21c. As described below, this is first provided with an optional conversion layer and then with a heat-sealable coating. In this example, the optional conversion layer and the heat-sealable coating are produced on one side, which, however, is only to be understood as an example. Similarly, conversion layers and/or heat-sealable coatings could also be produced on both sides of the cold strip 21c. The application of the conversion layer is also to be understood by way of example and the conversion layer can generally be omitted on one side or on both sides.

To produce the conversion layer, the cold strip 21c is unwound from a coil and, for example, fed to a phosphating step 26, which is configured here as a one-sided roll coating process. Alternatively, the phosphating solution can also be sprayed on, for example by electrostatic spraying 26a. Furthermore, the phosphating can also be carried out by running the cold strip 21c through a bath with the phosphating solution (not represented). However, the advantage of the roll coating method is that the application of the phosphating solution can be precisely adjusted even at high throughput speeds. Phosphating 26 is a preferred no-rinse method in which the phosphating agent, here zirconium phosphate, remains on the cold strip 21c, so that in particular no rinsing step is required. For this purpose, the cold strip 21c provided with the phosphating solution is guided through the drying furnace 28c so that the phosphating agent dries. As already described above, the phosphating step 26 is not absolutely necessary for implementing a method according to the invention. However, a conversion layer can be produced with a one-sided or two-sided phosphating step 26 on one side or on both sides of the cold strip 21d, which not only protects against corrosion, but in particular improves the adhesion of the subsequently applied heat-sealable

coating. Preferably, a chromium-free phosphating 26 is carried out so that the conversion layer produced on one or both sides does not contain any chromium that is harmful to health and is better suited for contact with food.

In method step 27, a heat-sealable coating containing polyolefins is lastly produced on the cold strip 21d, which is already provided with a conversion layer here by way of example. The heat-sealable coating is produced here by way of example by applying a water-based lacquer to the cold strip 21d and then baking it. The lacquer contains, by way of example, a polypropylene dispersion as a polyolefin dispersion. In addition, the lacquer contains, by way of example, N,N,N′,N′-Tetrakis(2-hydroxyethyl) adipamide as a crosslinking agent as well as PTFE-free wax. As with the phosphating 26, the lacquer is also applied in a one-sided roll coating process. Alternatively, spraying, in particular electrostatic spraying 27a of the lacquer, or, as a further alternative, running through a lacquer bath (not represented), is also possible here. To bake the lacquer, the cold strip 21d coated with the lacquer on one side is fed to a baking furnace 28d. The baking process takes place in such manner that a maximum metal temperature in the range of 200° C. to 300° C. is reached. The bake time is, by way of example, in the range of 5 s to 35 s. The result of the baking is the cold strip 21e provided with a heat-sealable coating on one side. This is then wound onto a coil for easier storage or transportation.

The aluminium alloy strip according to the invention, which was manufactured for example with the method according to the invention just described, can now in particular be used to manufacture a resealable beverage can lid. Since plastic elements for implementing a resealable beverage can lid can be securely and cost-effectively fastened by means of heat-sealing on the heat-sealable coating of the aluminium alloy strip according to the invention, the aluminium alloy strip according to the invention is particularly suitable for this purpose. The manufacture of at least one resealable beverage can lid takes place, for example, by at least one beverage can lid being punched out of the aluminium alloy strip according to the invention by means of suitable tools and then, if necessary, formed. The plastic elements for implementing the resealable mechanism can then be fastened on the at least one punched-out beverage can lid by means of heat-sealing.

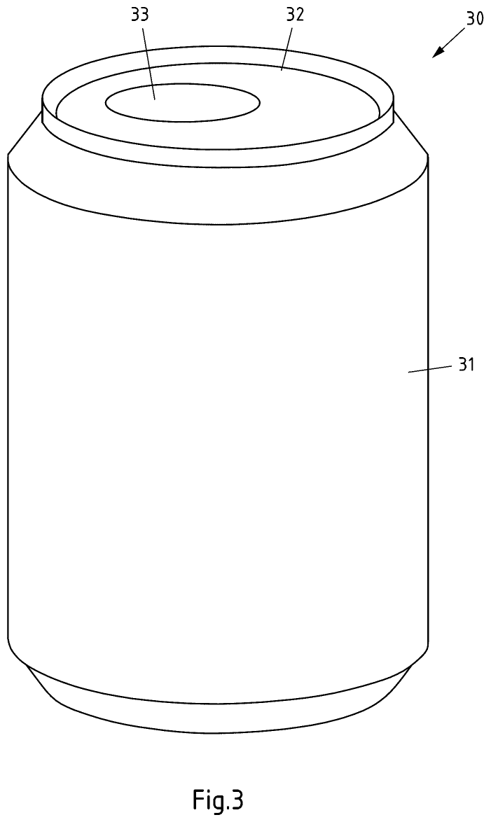

FIG. 3 shows, by way of example, in a schematic representation, a beverage can 30 according to the invention with a beverage can lid 32 according to the invention, which was manufactured by the use, according to the invention, of the aluminium alloy strip according to the invention just described. In addition to the beverage can lid 32, the beverage can 30 also has a beverage can body 31, which was connected airtight to the beverage can lid 32 via a beading. Other suitable connection methods, such as for example adhesive bonding, are also conceivable instead of the flange. While the beverage can body 31 is designed as a single part in this example, the beverage can body 31 can basically also be designed in multiple parts, in particular in two parts. An element 33 for implementing a resealable mechanism, which is, however, only schematically indicated, can be provided on the beverage can lid 32. The element 33 can then be fastened by means of heat-sealing on the heat-sealable coating of the outer side of the beverage can lid 32. In addition, the beverage can lid 32 in this example also has a heat-sealable coating on its inner side, which acts here as a highly functional barrier and protects both the beverage against the migration of aluminium from the beverage can lid 32 and the aluminium alloy of the beverage can lid 32 against an attack by the beverage.

Within the scope of the invention, laboratory tests were also carried out to examine, among other things, how the seal seam strength of the heat-sealable coating of the aluminium alloy strip according to the invention depends on various influencing parameters, in particular on the basis weight of the coating. For this purpose, two test specimens with dimensions of 290 mm×210 mm each were cut out of an aluminium alloy strip of the type AA5182. The aluminium alloy strip had been manufactured by performing the method steps described in connection with FIG. 2a, namely casting a rolling ingot, homogenising the rolling ingot, hot rolling the rolling ingot into a hot strip, and cold rolling the hot strip to a final thickness with optional intermediate annealing. In addition, the aluminium alloy strip had been subjected to a pretreatment of a two-sided chromium-free phosphating using zirconium phosphate to produce corresponding conversion layers on the aluminium alloy strip. The metal thickness of the aluminium alloy strip was 0.224 mm.

A heat-sealable coating, which contains polyolefin, was then produced on one side of the two test specimens just described in the laboratory. For this purpose, a water-based lacquer was first applied to one side of the test specimen. The water-based lacquer contained 2 to 6 wt % of an aqueous solution of a hydroxyalkylamide, 5 to 11 wt % of PTFE-free wax and as the remainder an aqueous polyolefin dispersion. The aqueous polyolefin dispersion was, by way of example, an aqueous polypropylene dispersion with a solids content of 40 to 50 wt %. The aqueous solution of a hydroxyalkylamide was a solution of 30 wt % of N,N,N′,N′-Tetrakis(2-hydroxyethyl) adipamide in slightly alkaline water, which contained 0.3 wt % of DMEA. When applying the water-based lacquer to the two test specimens, the target value of the basis weight of the resulting heat-sealable coating was 4 g/m² for the first test specimen and 12 g/m² for the second test specimen.

The applied lacquer was then baked in a laboratory furnace. For this purpose, the laboratory furnace was heated to a temperature of 295° C. and the two lacquered test specimens were placed in the laboratory furnace for 21 s each. As a result, the test specimens heated up and a maximum metal temperature of 243° C. was reached at the end of the respective heating process.

After baking the lacquer, the basis weight of the heat-sealable coating was determined for each of the two test specimens. For this purpose, a circular sample was punched out of the coated test specimens, which had a radius of 39.9 mm and correspondingly an area of 50.0 cm 2. The coated samples were weighed using a laboratory precision balance. The heat-sealable coating was then removed from the samples by burning. For this purpose, the samples were placed in a laboratory furance at a temperature of 550° C. for 15 minutes each, which caused the heat-sealable coating to thermally decompose. After burning, the samples were held in water for cooling and rubbed with a cloth soaked in solvent to remove any remaining lacquer residue from the surface. Lastly, the uncoated samples were weighed again and the basis weight of the heat-sealable coating was determined by forming the respective difference from the weight of the coated sample and the weight of the uncoated sample and dividing it by the area of the sample. This resulted in an basis weight of 4.1 g/m² for the first test specimen. A value of 11.7 g/m² was determined accordingly for the second test specimen.

Lastly, the seal seam strength of the heat-sealable coating was determined for each of the two test specimens. For this purpose, three test strips with a width of 15 mm were cut from each of the two test specimens using a sheet metal strip cutting machine. A similarly 15 mm wide strip of polypropylene film was then applied to one side of each of the six test strips by means of heat sealing. The thickness of the polypropylene film was 200 μm.

The heat sealing was carried out using a heat sealing machine with a sealing force of 90 N, a sealing time of 1 s and a sealing temperature of 180° C. Subsequently, the seal seam strength was determined for each of the six test strips in accordance with DIN 55529, with a pull-off angle of 180° being used instead of the pull-off angle of 90° specified in DIN 55529. Lastly, for each of the two test specimens, an average seal seam strength was calculated as an average value from the three test strips. The values determined can be found in the following Tab. 1.

TABLE 1

| | | |
|---|---|---|
| Test | Area | |
| specimen | weight | Average seal seam strength |

| | | | |
|---|---|---|---|
| 1 | 4.1 | g/m² | 40N |
| 2 | 11.7 | g/m² | 45N |

As the table shows, the seal seam strengths for both test specimens are above a value of 35 N, which is already sufficient to provide a sufficiently secure connection between the heat-sealable coating and the plastic elements, to be fastened, of a resealable beverage can lid. The seal seam strengths for both test specimens are even above a value of 39 N, which makes an even more secure connection possible. In contrast to the first test specimen, the second test specimen even reaches a value above 42 N, which leads to a particularly secure connection. In the case of the second test specimen, the higher seal seam strength can be attributed in particular to the higher basis weight of the heat-sealable coating.

Lastly, laboratory tests were also carried out within the scope of the invention to examine the porosity of the heat-sealable coating of the aluminium alloy strip according to the invention. For this purpose, two further test specimens 3 and 4 were cut out of an aluminium alloy strip of the type AA5182 in the same way as the two test specimens 1 and 2 described above and provided on one side with a heat-sealable coating by baking on a water-based lacquer. The two additional test specimens differed only in terms of the basis weight of the heat-sealable coating from the two test specimens already described above and were identical apart from that. The basis weight of the heat-sealable coating was 8.0 g/m² for the third test specimen and 12.0 g/m² for the fourth test specimen.

To examine the porosity, at least three beverage can lid shells were manufactured from the test specimens 3 and 4 by punching and forming. An “enamel rater” porosity measurement was then carried out on the coated inner side of the shells. For this purpose, an electrolyte solution was filled into a cylindrical test vessel, which was mounted so as to be horizontally rotatable, until about one third of the test vessel volume was filled. The electrolyte solution consisted of 98.8 wt % deionized water, 1.0 wt % NaCl and 0.2 wt % dioctyl sodium sulfosuccinate, with the latter serving to reduce the interfacial tension so that any pores that might be present were better filled by the electrolyte solution. After filling the electrolyte solution into the test vessel, the shell on which the porosity of the heat-sealable coating was to be measured was placed on the test vessel. The diameter of the test vessel was matched to the diameter of the shells, so that the shells could be fitted precisely. The test vessel was then evacuated via an opening that was located about halfway up its outer surface, so that the shell was pressed onto the test vessel and thus fixed in place due to the resulting overpressure of the laboratory environment. The test vessel was then rotated 180° horizontally so that the shell fixed thereto faced downwards. In this position, the electrolyte solution in the test vessel came into contact with the coated inner side of the shell. Furthermore, in this position, a first electrode, which was located inside the test vessel and was contacted from the outside via a cable, was also immersed in the electrolyte solution. A metal pin, which acted as a second electrode, was lastly used to contact the metal layer of the shell.

A direct voltage of 6.3 V was then applied to the two electrodes for actually carrying out the “enamel rater” porosity measurement. After a measuring time of 4 s, the strength of the current flowing between the two electrodes was measured. In this way, the current strength was determined for each of the shells manufactured from the test specimens 3 and 4. Lastly, the mean current strength of the porosity measurement was calculated for each test specimen as an average value over the at least three individual shells manufactured therefrom. The values determined are shown in Table 2 below.

TABLE 2

| | | |
|---|---|---|
| Test | Area | Average current strength |
| specimen | weight | in porosity measurement |

| | | | |
|---|---|---|---|
| 3 | 8.0 | g/m² | 1.6 mA |
| 4 | 12.0 | g/m² | 0.7 mA |

As the table shows, the measured average current strengths for both test specimens are not only below 5 mA, but also below 2 mA, for the fourth test specimen even below 1 mA. With these values, it can be assumed that the respective heat-sealable coatings, whose basis weight is in the range of 8 g/m² to 12 g/m², have a sufficiently low porosity for application on beverage can lids. It can therefore in particular be achieved that the heat-sealable coating of the aluminium alloy strip according to the invention adequately fulfils its property as an adhesion promoter and as a highly functional barrier for a resealable beverage can lid.

The further embodiments also constitute a component of the disclosure.

1. Aluminium alloy strip for manufacturing a beverage can lid, wherein the aluminium alloy strip has an aluminium alloy of the type AA5xxx,
characterised in that
the aluminium alloy strip has a heat-sealable coating, which contains polyolefin, on one side or on both sides.

2. Aluminium alloy strip according to embodiment 1, characterised in that
the polyolefin is at least partially cross-linked by a hydroxyalkylamide, preferably by N,N,N′,N′-Tetrakis(2-hydroxyethyl) adipamide.

3. Aluminium alloy strip according to embodiment 1 or 2,
characterised in that
the heat-sealable coating contains wax.

4. Aluminium alloy strip according to one of embodiments 1 to 3,
characterised in that
the heat-sealable coating has an basis weight of 1.0 g/m² to 20.0 g/m², preferably 2.0 g/m² to 14.0 g/m², particularly preferably 3.0 g/m² to 5.0 g/m² or 6.0 g/m² to 12.5 g/m², most preferably 3.5 g/m² to 4.5 g/m² or 6.5 g/m² to 12.0 g/m².

5. Aluminium alloy strip according to one of embodiments 1 to 4,
characterised in that
the heat-sealable coating, after heat-sealing against a polypropylene film with a sealing force of 90 N, a sealing time of 1 s and a sealing temperature of 180° C., has a seal seam strength of at least 35 N, preferably at least 39 N, particularly preferably at least 42 N, at a sealing seam width of 15 mm.

6. Aluminium alloy strip according to one of embodiments 1 to 5,
characterised in that
the heat-sealable coating has a porosity with which the current strength measured in the “enamel rater” porosity measurement at a 10 basis weight of the heat-sealable coating in the range of 8 g/m² to 12 g/m² is no more than 5 mA, preferably no more than 2 mA, particularly preferably no more than 1 mA, wherein the “enamel rater” porosity measurement is carried out with a voltage of 6.3 V and the current strength is determined after a measuring time of 4 s.

7. Aluminium alloy strip according to one of embodiments 1 to 6,
characterised in that
the aluminium alloy strip has an aluminium alloy of the type AA5052 or AA5182.

8. Aluminium alloy strip according to one of embodiments 1 to 7,
characterised in that
the aluminium alloy strip has a metal thickness of 0.1 mm to 0.3 mm, preferably of 0.15 mm to 0.25 mm.

9. Aluminium alloy strip according to one of embodiments 1 to 8,
characterised in that
the aluminium alloy strip on one side or on both sides additionally has a chromium-free conversion layer, which preferably contains zirconium phosphate.

10. Method for manufacturing an aluminium alloy strip, in particular for manufacturing an aluminium alloy strip according to one of embodiments 1 to 9, wherein the method comprises:
casting a rolling ingot or a casting strip from an aluminium alloy of the type AA5xxx;
homogenising the rolling ingot or the casting strip;
hot rolling the rolling ingot or the casting strip into a hot strip;
cold rolling the hot strip to final thickness with at least one intermediate annealing or without intermediate annealing;
   characterised in that
   the method further comprises:
producing a heat-sealable coating on one side or on both sides of the aluminium alloy strip cold-rolled to final thickness, wherein the heat-sealable coating contains polyolefin.

11. Method according to embodiment 10,
characterised in that
the heat-sealable coating is produced by applying and baking a lacquer.

12. Method according to embodiment 10 or 11,
characterised in that
the baking of the lacquer takes place in such manner that a maximum metal temperature in the range of 200° C. to 300° C., preferably in the range of 220° C. to 260° C., 25 is reached.

13. Use of an aluminium alloy strip according to one of embodiments 1 to 9 for manufacturing a resealable beverage can lid.

14. Resealable beverage can lid,
characterised in that
the beverage can lid is manufactured from an aluminium alloy strip according to one of embodiments 1 to 9.

15. Beverage can with a resealable beverage can lid,
characterised in that
the beverage can lid made of an aluminium alloy strip according to one of the embodiments

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. Aluminium alloy strip for manufacturing a beverage can lid, wherein the aluminium alloy strip has an aluminium alloy of the type AA5xxx,
wherein
the aluminium alloy strip has a heat-sealable coating, which contains polyolefin, on one side or on both sides, wherein the polyolefin is at least partially cross-linked by N,N,N′,N′-Tetrakis(2-hydroxyethyl) adipamide, and the heat-sealable coating contains wax.

2. Aluminium alloy strip according to claim 1
characterised in that
the heat-sealable coating has an basis weight of 1.0 g/m² to 20.0 g/m², preferably 2.0 g/m² to 14.0 g/m², particularly preferably 3.0 g/m² to 5.0 g/m² or 6.0 g/m² to 12.5 g/m², most preferably 3.5 g/m² to 4.5 g/m² or 6.5 g/m² to 12.0 g/m².

3. Aluminium alloy strip according to claim 1,
wherein
the heat-sealable coating, after heat-sealing against a polypropylene film with a sealing force of 90 N, a sealing time of 1 s and a sealing temperature of 180° C., has a seal seam strength of at least 35 N, preferably at least 39 N, particularly preferably at least 42 N, at a sealing seam width of 15 mm.

4. Aluminium alloy strip according to claim 1,
wherein
the heat-sealable coating has a porosity with which the current strength measured in the “enamel rater” porosity measurement at an basis weight of the heat-sealable coating in the range of 8 g/m² to 12 g/m² is no more than 5 mA, preferably no more than 2 mA, particularly preferably no more than 1 mA, wherein the “enamel rater” porosity measurement is carried out with a voltage of 6.3 V and the current strength is determined after a measuring time of 4 s.

5. Aluminium alloy strip according to claim 1,
wherein
the aluminium alloy strip has an aluminium alloy of the type AA5052 or AA5182.

6. Aluminium alloy strip according to claim 1,
wherein
the aluminium alloy strip has a metal thickness of 0.1 mm to 0.3 mm, preferably of 0.15 mm to 0.25 mm.

7. Aluminium alloy strip according to claim 1,
wherein
the aluminium alloy strip on one side or on both sides additionally has a chromium-free conversion layer, which preferably contains zirconium phosphate.

8. Method for manufacturing an aluminium alloy strip, in particular for manufacturing an aluminium alloy strip according to claim 1, wherein the method comprises:
casting a rolling ingot or a casting strip from an aluminium alloy of the type AA5xxx;
homogenising the rolling ingot or the casting strip;
hot rolling the rolling ingot or the casting strip into a hot strip;
cold rolling the hot strip to final thickness with at least one intermediate annealing or without intermediate annealing;
wherein
the method further comprises:
producing a heat-sealable coating on one side or on both sides of the aluminium alloy strip cold-rolled to final thickness, wherein the heat-sealable coating contains polyolefin, wherein the heat-sealable coating is produced by applying and baking a lacquer, wherein the lacquer contains a polyolefin dispersion, N,N,N′,N′-Tetrakis(2-hydroxyethyl) adipamide, as a crosslinking agent and wax.

9. Method according to claim 8,
wherein
the lacquer is a water-based lacquer and the lacquer contains a polyolefin dispersion, wherein the polyolefin dispersion is preferably a polyethylene dispersion or a polypropylene dispersion or a mixture of both.

10. Method according to claim 8,
wherein
the wax is preferably a PTFE-free wax, particularly preferably carnauba wax, polyethylene wax, polypropylene wax, polyamide wax or a mixture of said waxes.

11. Method according to claim 8,
wherein
the water-based lacquer contains 1 to 15 wt %, preferably 2 to 6 wt % of a N,N,N′,N′-Tetrakis(2-hydroxyethyl) adipamide, 1 to 20 wt %, preferably 5 to 11 wt % of PTFE-free wax and as the remainder an aqueous polyolefin dispersion, wherein the aqueous polyolefin dispersion preferably has a solids content of up to 60 wt %, preferably 40 to 50 wt %.

12. Method according to claim 10,
wherein
the baking of the lacquer takes place in such manner that a maximum metal temperature in the range of 200° C. to 300° C., preferably in the range of 220° C. to 260° C., is reached.

13. Use of an aluminium alloy strip according to claim 1 for manufacturing a resealable beverage can lid.

14. Resealable beverage can lid,
wherein
the beverage can lid is manufactured from an aluminium alloy strip according to claim 1.

15. Beverage can with a resealable beverage can lid,
wherein
the beverage can lid is manufactured from an aluminium alloy strip according to claim 1.
